(19) United States
(12) Patent Application Publication
(10) Pub. No.: US 2016/0239862 A1
(43) Pub. Date: Aug. 18, 2016

(54) METHOD OF DISCOUNT SERVICE ACCORDING TO THE GOODS PURCHASE USE SEQUENCE, AND APPARATUS THEREOF

(71) Applicant: SK Planet Co., Ltd., Gyeonggi-do (KR)

(72) Inventor: Sebyung KWAK, Seoul (KR)

(73) Assignee: SK Planet Co., Ltd., Gyeonggi-do (KR)

(21) Appl. No.: 15/015,874

(22) Filed: Feb. 4, 2016

(30) Foreign Application Priority Data
Feb. 16, 2015 (KR) 10-2015-0023634

(51) Int. Cl. G06Q 30/02

(52) U.S. Cl. CPC G06Q 30/0233; G06Q 30/0225

(57) ABSTRACT

When an available affiliated store registered in units of groups is used, the service apparatus manages group members' sequence of using the affiliated store, cumulative usage histories, and cumulative payment amounts to calculate a discount rate according to the usage sequence, the cumulative usage histories, and the cumulative payment amounts. The discount rate can be calculated in proportion to the usage sequence. By calculating and providing a discount rate of a group member according to the cumulative number of uses and a cumulative payment amount, it is possible to promote friendship, share favorite stores, and share reviews of visited stores among group members, and thus customers' consumption activity can be promoted.

### CROSS-REFERENCE TO RELATED APPLICATION

This application claims priority to and the benefit of Korean Patent Application No. 10-2015-0023634 filed in the Korean Intellectual Property Office on Feb. 16, 2015, the entire contents of which are incorporated herein by reference.

### TECHNICAL FIELD

The present invention relates to technology for providing discounts differentiated according to the sequence of using an affiliated store, and more particularly, to a discount service method according to the sequence of using an affiliated store which manages, when a group member uses a previously registered affiliated store, the sequence of group members using the affiliated store, calculates a discount rate according to the sequence of use, and applies the discount rate to an amount to be paid to perform a payment process, and an apparatus for the discount service method.

### BACKGROUND

Description made here only provides background information of present embodiments and does not constitute conventional technology.

With the drastic development of information and communications technology, various kinds of terminals, such as a mobile communication terminal, a personal computer (PC), etc., are implemented to perform a variety of functions.

For example, a mobile communication terminal is recently being implemented not only to use basic voice communication functions but also to use a variety of functions, such as data communication, capturing photography or video using a camera, playing of a music or video file, executing a game, viewing of broadcasts, and so on.

Technology for increasing functions that can be performed in such a terminal is under constant development, which is focused on software improvement technology as well as hardware improvement technology.

In addition to general communication functions such as voice communication and message transmission and reception, a mobile communication terminal typically has various additional functions such as a television (TV) viewing function (e.g., a mobile broadcasting function such as a digital multimedia broadcasting (DMB) function or a digital video broadcasting (DVB) function), a music playing function (e.g., a Moving Picture Experts Group Audio Layer-3 (MP3) function), a photography function, an Internet access function, and so on.

Also, with the recent development in the form of a smart phone in which a user can install various user functions as he or she likes based on an open source operating system (OS), a mobile communication terminal is providing a variety of convenient and entertaining functions. Since a recent mobile communication terminal supports a user in easily obtaining an application having various desired functions due to activation of an open market and can process many functions which are processed by a PC due to improvements in performance, a variety of services are being provided.

As online or offline gatherings in which individual users can obtain information required to determine stores for product purchase are activated, a variety of communities and gatherings are being formed. However, there is the inconvenience of searching for information to obtain store information by oneself.

Further, stores use various mobile advertising marketing strategies to attract regular customers. In particular, service in which customers' acquaintances are used is being activated through blog promotions, advertisement postings, social network service (SNS) marketing strategies, and a point and recommender-accumulating discount system.

However, existing service is inconvenient in that customers may be exposed to an unreliable advertising service and it is difficult to exchange information on stores in use or receive a discount service.

### PRIOR ART

### Patent Literature

Korean Unexamined Patent Publication No. 2004-0023023, published on May 18, 2014 (title: Member discount method and system for attracting new member)

### SUMMARY

The present invention is directed to, when members of the same group use an affiliated store, calculating discount rates by checking the sequence of the respective group members using the affiliated store, so that the group members are provided with a discount service.

Also, since it is possible to increase a discount rate of an affiliated store used commonly by a group, a discount rate proportional to the number of uses is provided upon a visit to a favorite store, and rational consumption is enabled.

Further, the present invention is directed to providing a discount service method according to the sequence of using an affiliated store which enables group members to share favorite stores and reviews of visited stores as reliable information and is useful for affiliated stores attracting regular customers, and an apparatus for the discount service method.

One aspect of the present invention provides a service apparatus for a discount according to the sequence of using an affiliated store, the service apparatus including a storage module configured to store group member information including at least one of lists of affiliated stores available for respective groups, identification information of respective members, and terminal identification information, a group member authentication module configured to receive a payment request from an affiliated store and authenticate whether the payment request is a payment request of a group member by comparing the payment request with the group member information, an affiliated store usage management module configured to manage affiliated store usage information including at least one of a sequence of using the affiliated store, a name of the group member, a history of cumulative uses of the affiliated store, and a cumulative payment amount based on the payment request of the group member, and a discount rate management module configured to calculate a discount rate according to the sequence of using the affiliated store when the payment request is authenticated to be a payment request of a group member.

In the service apparatus, the discount rate management module may calculate the discount rate in proportion to the sequence of using the affiliated store.

In the service apparatus, the discount rate management module may set one or more threshold discount rates, and change a variation of the discount rate when the calculated discount rate reaches the set threshold discount rates.

In the service apparatus, when a predetermined time period elapses, the discount rate management module may initialize the discount rate to manage the sequence of using the affiliated store, and calculate a discount rate in proportion to the sequence of using the affiliated store.

In the service apparatus, the discount rate management module may set one or more target values of the sequence of using the affiliated store and target-value-specific discount rates, and calculate the discount rate by comparing the sequence of using the affiliated store and the one or more target values.

In the service apparatus, the discount rate management module may modify the calculated discount rate according to at least one of the history of cumulative uses of the affiliated store and the cumulative payment amount.

Another aspect of the present invention provides a method for a service apparatus to provide a discount according to a sequence of using an affiliated store, the method including setting group member information including at least one of lists of affiliated stores available for respective groups, identification information of members of the groups, and terminal identification information of the respective members, managing affiliated store usage information including at least one of group members' sequence of using the affiliated store, histories of cumulative uses of the affiliated store, and cumulative payment amounts, calculating a discount rate according to the sequence of using the affiliated store when a payment is requested by a group member, and applying the calculated discount rate to perform a payment process.

In the method for a service apparatus to provide a discount, the calculating of the discount rate may include calculating the discount rate in proportion to the sequence of using the affiliated store.

In the method for a service apparatus to provide a discount, the calculating of the discount rate may further include setting one or more threshold discount rates, and changing a variation of the discount rate when the calculated discount rate reaches the threshold discount rates.

In the method for a service apparatus to provide a discount, the calculating of the discount rate may further include changing the calculated discount rate according to at least one of the histories of cumulative uses of the affiliated store and the cumulative payment amounts.

In the method for a service apparatus to provide a discount, the calculating of the discount rate may include designating one or more target values of the sequence of using the affiliated store and discount rates corresponding to the target values, determining whether the sequence of using the affiliated store reaches the target values, and calculating and applying the designated discount rates to an amount to be paid when the sequence of using the affiliated store reaches the target values.

According to embodiments of the present invention, a group of people having similar preferences and hobbies or a social gathering uses a selected affiliated store to receive a discount service according to a usage sequence, and thus may obtain information on the affiliated store and share reliable reviews of the affiliated store in the group.

The present invention enables a group to be provided with a discount service from an affiliated store used by the group, thereby leading to rational and economical consumption.

The present invention manages a group's cumulative number of uses, so that a discount is provided when a set target number of uses is achieved. Therefore, it is possible to arouse a desire for achievement and a desire for purchasing.

Since a group's cumulative number of uses and cumulative payment amount are managed, the present invention is effective in member management and may be used in marketing for attracting regular customers.

### BRIEF DESCRIPTION OF DRAWINGS

FIG. 1 is a diagram showing an overall configuration of a system for providing a discount service based on the sequence of using an affiliated store according to embodiments of the present invention.

FIG. 2 is a block diagram showing a detailed configuration of a discount service apparatus based on the sequence of using an affiliated store according to embodiments of the present invention.

FIG. 3 is a flowchart illustrating a service method of the discount service apparatus based on the sequence of using an affiliated store according to embodiments of the present invention.

FIG. 4 is a flowchart illustrating a method of calculating a discount rate proportional to the sequence of using an affiliated store according to a first embodiment of the present invention.

FIG. 5 is a flowchart illustrating a method of providing a discount rate dependent on a target value of a usage sequence according to a second embodiment of the present invention.

FIG. 6 shows an example of a structure of a member information database (DB) in a service apparatus according to embodiments of the present invention.

FIG. 7 shows an example of a service usage information DB managed by an affiliated store usage management module according to embodiments of the present invention.

FIG. 8 is an example of a screen illustrating a method of providing a discount based on the sequence of using an affiliated store according to the first embodiment of the present invention.

FIG. 9 is an example of a screen illustrating a method of providing a discount based on the sequence of using an affiliated store according to the second embodiment of the present invention.

FIG. 10 is a diagram showing an operating environment of the discount service apparatus based on the sequence of using an affiliated store according to embodiments of the present invention.

### DETAILED DESCRIPTION

Embodiments of the present invention will now be described more fully with reference to the accompanying drawings to clarify features and advantages of the present invention.

In the detailed description of embodiments of the present invention, when detailed descriptions on the known art related to the present invention are determined to obscure the subject matter of the present invention, the detailed descriptions will be omitted. Throughout the drawings, like elements are referred to be like numerals within the limits of the possible.

Terms or words used in this specification and claims described below are not to be construed as common or dictionary meanings but are to be construed as meanings and concepts in accordance with the technical spirit of the present invention based on a principle that the inventor can define terms appropriately for the best explanation of his or her own invention. Embodiments described in the present specification and configurations shown in the drawings are merely embodiments of the present invention and do not represent the whole technical spirit of the present invention. Thus, it is to be understood that there can be various equivalents and modifications at the filing data of the present invention.

Although terms including ordinal numbers, such as a first, a second, etc., may be used to describe various components, the components should not be defined by such terms. Such terms are used only for the purpose of distinguishing one component from another component. For example, a first component may be named a second component without departing from the scope of the present invention and, similarly, the second component may also be named the first component.

It will be understood that when a component is referred to as being “connected” or “coupled” to another component, the component can be logically or physically connected or coupled to the other component. In other words, the component may be connected or coupled to the other component directly or indirectly, or intervening components may be present.

The terminology used herein to describe embodiments of the invention is not intended to limit the scope of the invention. Elements of the invention referred to in the singular may number one or more, unless the context clearly indicates otherwise. It will be further understood that the terms “comprise,” “include,” when used herein, specify the presence of stated features, numbers, steps, operations, components, parts, or combinations thereof, but do not preclude the presence or addition of one or more other features, numbers, steps, operations, components, parts, or combinations thereof.

Embodiments of the present invention include a computer-readable medium which has computer-executable instructions or has or transfers a data structure stored therein. The computer-readable medium may be an arbitrary available medium which is accessible by a general or special purpose computer system. For example, the computer-readable medium may include a physical storage medium, such as a random access memory (RAM), a read-only memory (ROM), an erasable programmable ROM (EPROM), a compact disc ROM (CD-ROM), other optical disk storage devices, a magnetic disk storage device, other magnetic storage devices, or any other media which may be used to store and transfer predetermined program code means having the form of computer-executable instructions, computer-readable instructions, or data structures and may be accessed by a general or special purpose computer system, but is not limited thereto.

In the following descriptions and claims, a “network” is defined as one or more data links that enable transmission of electronic data between computer systems and/or modules. When information is transmitted or provided to a computer system through a network or another (wired, wireless, or a combination thereof) communication connection, the connection may be understood as a computer-readable medium. Computer-readable instructions include, for example, instructions and data which cause a general-purpose computer system or a special-purpose computer system to perform a specific function or a group of functions. Computer-executable instructions may be, for example, binary code, intermediate format instructions such as an assembly language, or even source code.

Embodiments of the present invention may be implemented in a network computing environment with various types of computer system configurations including personal computers (PCs), laptop computers, handheld devices, multiprocessor systems, microprocessor-based or programmable consumer electronics, network PCs, minicomputers, mainframe computers, mobile telephones, personal digital assistants (PDAs), pagers, and so on. The present invention may also be implemented in a distributed system environment in which local and remote computer systems linked by a wired data link, a wireless data link, or a combination thereof through a network both perform tasks. In a distributed system environment, program modules may be located in both local and remote memory storage devices.

Hereinafter, a discount service method based on the sequence of using an affiliated store and an apparatus for the same according to embodiments of the present invention will be described in detail with reference to the drawings.

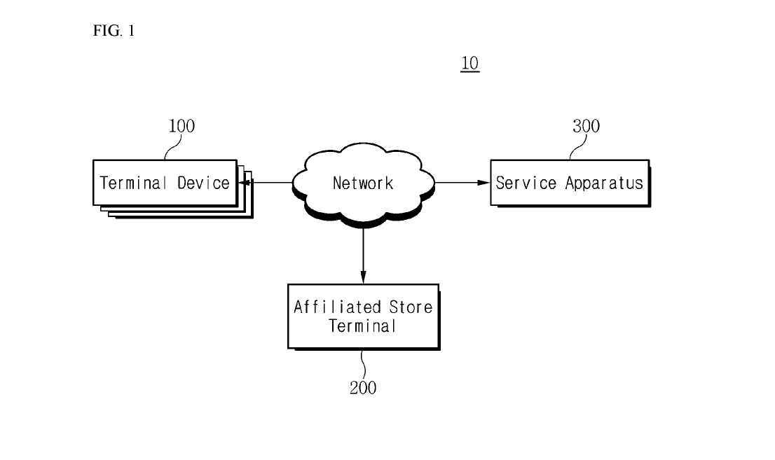

First, an overall configuration of a discount service system based on the sequence of using an affiliated store according to embodiments of the present invention will be described with reference to FIG. 1.

FIG. 1 is a diagram schematically showing an overall configuration of a system for providing a discount service based on the sequence of using an affiliated store according to embodiments of the present invention.

Referring to FIG. 1, the system for providing a discount service according to the sequence of using an affiliated store may include one or more terminal devices 100, an affiliated store terminal 200, and a service apparatus 300 connected through a network.

As brief descriptions of the respective components, first, the terminal devices 100 according to embodiments of the present invention represent user devices that are capable of transceiving various data through the network according to manipulation of users.

The terminal devices 100 according to embodiments of the present invention may be any of a tablet PC, a laptop computer, a PC, a smart phone, a PDA, a smart television (TV), a mobile communication terminal, and so on.

Also, the terminal devices 100 are electronic devices that perform voice or data communication using a network, representing electronic devices having a memory which stores a browser, a program, and a protocol for communicating with the service apparatus 300 through the network, a microprocessor for executing a variety of programs for calculation and control, and so on.

In other words, the terminal devices 100 may be any electronic devices that are capable of performing server-client communication with the service apparatus 300 and providing a customized service, and are a broad concept including communication and computing devices such as a laptop computer, a mobile communication terminal, a PDA, and so on. The terminal devices 100 may be manufactured to have a touch screen, but are not limited to the form having a touch screen.

By communicating with the service apparatus 300 and the affiliated store terminal 200 operating in conjunction with each other through the network, the terminal devices 100 are able to transceive data for providing a discount service according to the sequence of using an affiliated store.

For example, to use the discount service according to the sequence of using an affiliated store, the terminal devices 100 may transmit group information to the service apparatus 300 through the network.

Also, to use the discount service according to the sequence of using an affiliated store, the terminal devices 100 may transmit information on affiliated stores available for respective groups to the service apparatus 300 through the network.

Further, to use the discount service according to the sequence of using an affiliated store, the terminal devices 100 may transmit member name information and terminal identification information corresponding to respective members to the service apparatus 300 through the network.

Moreover, to use an affiliated store, the terminal devices 100 may transmit a signal input for a payment request to the affiliated store terminal 200 through the network.

The affiliated store terminal 200 according to embodiments of the present invention is an electronic device that is able to transceive data for a group account payment service by communicating with the service apparatus 300 through the network.

For example, as a terminal in which functions of a cash register and a computer terminal are combined, the affiliated store terminal 200 may be a point of sales (POS) terminal that not only calculates purchase price but also collects and processes various information and data required for retail management.

Also, the affiliated store terminal 200 may be a terminal that is equipped with a card payment machine to store data, such as a product name, a price, etc., at a sales time, or a terminal, such as a credit authorization terminal (CAT), that performs a payment process.

The affiliated store terminal 200 according to embodiments of the present invention may receive the signal for payment request from the terminal device 100 and transmit a payment request to the service apparatus 300.

Also, the affiliated store terminal 200 may transmit the payment request to the service apparatus 300 through the network, apply a discount rate calculated by the service apparatus 300 to approve the payment, and receive a payment result.

In addition, the affiliated store terminal 200 may output the payment result as a receipt or display the payment result through a display device.

The service apparatus 300 according to embodiments of the present invention is a component that operates in conjunction with the one or more terminal devices 100 and the affiliated store terminal 200 through the network to provide the discount service according to the sequence of using the affiliated store. The service apparatus 300 may provide the service of checking whether the payment request received from the affiliated store terminal 200 has been made by a member of a group previously stored by the terminal devices 100.

When a user corresponding to a terminal device 100 which has transmitted the input signal to the affiliated store terminal 200 making the payment request is authenticated as a member of the previously stored group, the service apparatus 300 may calculate a discount rate with reference to affiliated store usage information of the group member.

In other words, the service apparatus 300 receives the payment request from the affiliated store terminal 200 which receives and transmits the payment request, calculates the discount rate by checking previously stored member information and affiliated store usage information, and manages the payment request to update the affiliated store usage information when the payment request is authenticated as a payment request of a group member.

Also, the service apparatus 300 according to a first embodiment of the present invention calculates a discount rate based on the sequence of using the affiliated store in the breakdown of affiliated store usage by group members to perform a payment process with an amount to which a calculated discount rate is applied.

For example, when a group member uses the affiliated store for the first time, a discount rate may be 0%, and when any one of group members uses the affiliated store for the second time, the discount rate proportionally increases. When the first discount rate is 0%, the second discount rate may be 1%. Then, a discount rate of 2% may be applied to a group member who uses the affiliated store for the third time. As described above, the service apparatus 300 according to the first embodiment of the present invention calculates a discount rate in proportion to a group member's sequence of using the affiliated store, and the discount rate may gradually increase. This is effective in attracting group members to be regular customers of the affiliated store.

Also, when the service apparatus 300 according to the first embodiment of the present invention calculates a discount rate in proportion to a group member's sequence of using the affiliated store, the discount rate gradually and endlessly increases, and thus a threshold discount rate may be set.

In other words, when a discount rate calculated by the service apparatus 300 according to the first embodiment of the present invention exceeds the preset threshold discount rate, a variation of the discount rate increasing in proportion to a usage sequence may be reduced.

Also, when the service apparatus 300 according to the first embodiment of the present invention calculates a discount rate in proportion to a group member's sequence of using the affiliated store, the discount rate endlessly increases. Therefore, when a predetermine time period elapses, the discount rate is initialized and an affiliated store discount rate may be managed.

For example, the discount rate may be initialized on the first day of each month. Then, the discount rate is set to an initial value on the first day of each month and increases in proportion to a sequence of group members using the affiliated store until the last day of the month.

The service apparatus 300 according to a second embodiment of the present invention manages a history of a member using the affiliated store, and sets one or more target values of a sequence of members using the affiliated store and target-value-specific discount rates corresponding to the target values.

In other words, when members do not achieve a usage number corresponding to a target value, the corresponding discount rate is not applied, and when the number of times in which members use the affiliated store reaches the target value, it is possible to apply the discount rate.

The service apparatus 300 according to a third embodiment of the present invention may manage histories of group members using the affiliated store to calculate a discount rate according to a usage sequence, and check the numbers of times using the affiliated store and cumulative payment amounts in the histories of using the affiliated store to differentially and additionally apply the discount rate.

For example, the highest additional discount rate may be applied to a group member who has the largest number of times of using the affiliated store in the group.

Also, the highest additional discount rate may be applied to a group member who has the largest cumulative payment amount for the affiliated store in the group.

Further, the highest additional discount rate may be applied to group members whose numbers of times using the affiliated store or cumulative payment amounts are ranked fifth or higher in the group, and the second highest additional discount rate may be applied to group members whose numbers of times using the affiliated store or cumulative payment amounts are ranked sixth to tenth. In this way, it is possible to apply differentiated additional discount rates to respective sections.

As described above, the service apparatus 300 according to the third embodiment of the present invention may manage the breakdown of cumulative usage of the affiliated store by group members to refer to the managed breakdown of affiliated store usage, calculate a discount rate according to the sequence of a group member using the affiliated store, and modify the calculated discount rate by additionally applying a discount rate differentiated according to the breakdown of affiliated store usage.

Also, the service apparatus 300 according to embodiments of the present invention may perform a payment process by applying a calculated discount rate to the payment request received from the affiliated store terminal 200, and transmit a result of discount rate calculation according to the breakdown of affiliated store usage, whether or not the payment request is processed, and a payment result to the terminal device 100 and the affiliated store terminal 200.

In the system for providing the discount service according to the sequence of using an affiliated store constituted as described above, a constitution of a service apparatus according to embodiments of the present invention will be described in detail below with reference to an accompanying drawing.

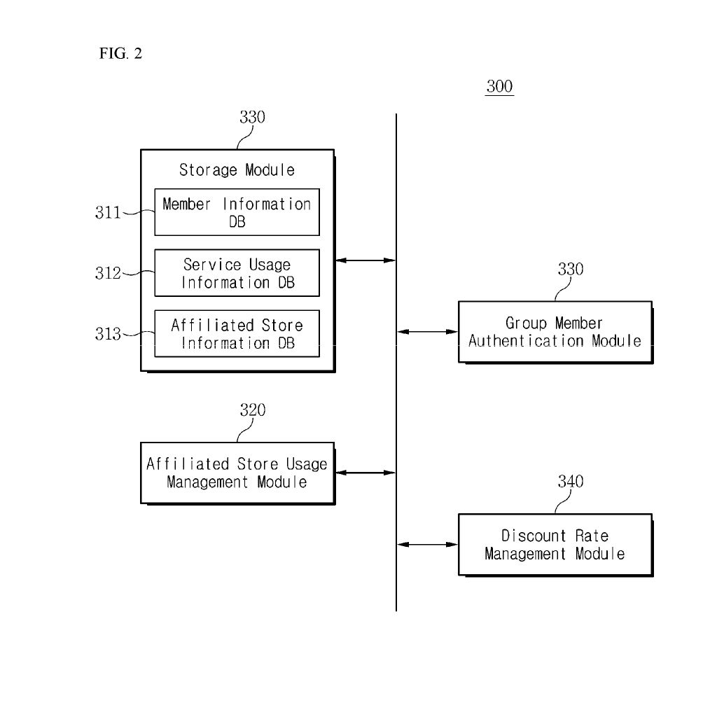

FIG. 2 is a block diagram showing a detailed configuration of the service apparatus 300 according to embodiments of the present invention in the system for providing the discount service according to the sequence of using an affiliated store.

Referring to FIG. 2, the service apparatus 300 according to embodiments of the present invention may include a storage module 310, an affiliated store usage management module 320, a group member authentication module 330, and a discount rate management module 340.

Here, each “module” is a component that performs a predetermined function, and may be implemented as hardware, software, or a combination of hardware and software. For example, a module may represent a program module, which is executed by a processor to perform a predetermined function.

The storage module 310 according to embodiments of the present invention receives a group account payment request from the affiliated store terminal 200 and manages information related to a discount service to provide the discount service according to the sequence of using an affiliated store. The storage module 310 may be a hardware storage medium or a data module (a file system or a database (DB) system) recorded in a hardware storage medium to store the information.

The storage module 310 may include a member information DB 311 that manages members registered with the discount service to use the discount service according to the sequence of using the affiliated store, a service usage information DB 312 required to provide the service, and an affiliated store information DB 313 registered to provide the service.

The storage module 310 may include magnetic media such as a hard disk, a floppy disk, and a magnetic tape, optical media such as a CD-ROM and a digital video disk (DVD), magneto-optical media such as a floptical disk, a ROM, a RAM, and a flash memory.

The member information DB 311 according to embodiments of the present invention may store at least one of identification information of members registered with the service, terminal information corresponding to the members, and a group to which the members belong.

The member identification information may include information for identifying users, such as member names, member identifiers (IDs), and personal identification codes of the members, and the terminal information may include terminal identification information corresponding to the members.

Also, as the group to which the members belong, information on a group registered to use the present invention's discount service according to the sequence of using the affiliated store may be stored, and one or more groups may be stored according to selections of the members.

The member information DB 311 according to embodiments of the present invention may be registered and managed in units of groups. In other words, it is possible to subscribe to the discount service according to the sequence of using the affiliated store in units of individuals or groups, and the member information DB 311 may be registered through the affiliated store terminal 200 or may be directly registered by a member through interoperation between a terminal device 100 and the service apparatus 300.

The service usage information DB 312 according to embodiments of the present invention may be stored and managed according to groups or affiliated stores.

As described above, the service usage information DB 312 includes one or more groups registered to use the present invention's discount service according to the sequence of using an affiliated store, the list of affiliated stores registered according to the groups, and purchase information according to the numbers of times using the affiliated stores.

The purchase information may include information on members who have made payments, the member-specific cumulative numbers of times using the affiliated stores, the member-specific cumulative payment amounts, and discount information of the payments.

Here, as the list of affiliated stores, affiliated stores to be used according to groups may be selected and registered from the affiliated store information DB 313 registered to provide the discount service according to the sequence of using an affiliated store.

At this time, in relation to the list of affiliated stores, a store may be affiliated through an input signal from the terminal device 100 or the service apparatus 300.

As described above, after selecting and registering stores that want to be affiliated according to each group with reference to the affiliated store information DB 313, it is possible to store a list of the selected affiliated stores in the service usage information DB 312 of the storage module 310 of the service apparatus 300.

The affiliated store information DB 313 may be registered through a network connection between the affiliated store terminal 200 and the service apparatus 300 to use the present invention's discount service according to the sequence of using an affiliated store, and may be information including affiliated store identification information, affiliated store names, affiliated store addresses (website addresses in the case of online stores), and representative sales products of affiliated stores.

The affiliated store identification information may be unique numbers of respective affiliated stores. For example, the affiliated store identification information may be any one of telephone numbers of affiliated stores, business registration numbers, affiliated store numbers, and code numbers for affiliated store management.

Next, the affiliated store usage management module 320 according to embodiments of the present invention may receive a payment request from the affiliated store terminal 200 and process the payment request based on information included in the payment request.

The affiliated store usage management module 320 may manage affiliated store lists and information on members who have made payments managed by the service usage information DB 312, member-specific cumulative numbers of times using affiliated stores, and member-specific cumulative payment amounts.

In other words, when an input signal for a payment of a specific terminal device 100 is generated and the affiliated store terminal 200 receiving the input signal transmits a payment request to the service apparatus 300, the service apparatus 300 may receive the payment request, determine who among group members has made the payment request based on the payment request and the member information DB 311 through the group member authentication module 330, authenticate who the member is, and manage the authenticated member by applying a payment result of a new payment request to the authenticated member.

When the service apparatus 300 according to embodiments of the present invention receives a payment request, the group member authentication module 330 in the service apparatus 300 performs member authentication to determine who has made the payment request.

Specifically, one member of a certain group may visit an affiliated store in the list of affiliated stores available for the group and transmit a payment request to the affiliated store terminal 200 of the affiliated store. Subsequently, the affiliated store terminal 200 may transmit the payment request to the service apparatus 300, and the service apparatus 300 may determine who has made the payment request.

In other words, as described above, when a payment request is received from the affiliated store terminal 200, the group member authentication module 330 in the service apparatus 300 according to embodiments of the present invention may map member information which is received together with the payment request to the member information DB 311, and authenticate which member in which group has made the payment request. Here, the payment request is made in the affiliated store terminal 200 by a request of a member of a certain group.

At this time, the member who wants to make the payment may transmit at least one piece of member information among his or her name, identification information, and member ID together with the payment request.

Therefore, by mapping the member information to the member information DB 311 of the storage module 310, it is possible to perform member authentication.

The discount rate management module 340 in the service apparatus 300 according to embodiments of the present invention performs the function of calculating a discount rate of an affiliated store available for group members to provide the discount service according to the sequence of using an affiliated store.

When each member makes a payment, the discount rate management module 340 may refer to the service usage information DB 312 in the storage module 310 to calculate a discount rate.

The service usage information DB 312 may include one or more groups registered to receive the discount service according to a usage sequence, a list of affiliated stores selected and registered according to the groups through the affiliated store information DB 313, member information according to the numbers of times using the affiliated stores, the member-specific cumulative numbers of times using the affiliated stores, member-specific cumulative payment amounts, and discount information of the payments.

In other words, the discount rate management module 340 according to embodiments of the present invention may calculate a discount rate according to a group member's sequence of using an affiliated store, and calculate the discount rate with reference to the member-specific cumulative numbers of times using the affiliated stores and the member-specific cumulative payment amounts in the service usage information DB 312 of the storage module 310.

Specifically, when a product purchase is made in an affiliated store available for members of a certain group, the discount rate management module 340 in the service apparatus 300 according to the first embodiment of the present invention may check the sequence of using the affiliated store by mapping member information received together with a payment request to the service usage information DB 312, and calculate a discount rate proportional to the member's usage sequence with reference to the member's usage sequence in the purchase history of members according to the usage sequence.

In addition, when a discount rate is calculated in proportion to the usage sequence, one or more threshold discount rates may be set for the calculated discount rate.

When a discount rate increasing in proportion to a sequence of a member of a certain group using an affiliated store reaches the preset one or more threshold discount rates, the discount rate management module 340 may change a variation of the discount rate to be slightly smaller.

In addition, the discount rate management module 340 may set a predetermined time period for the discount service of increasing a discount rate set by the affiliated store terminal 200 or the service apparatus 300 in proportion to a usage number. After the affiliated store is used for the first time, when the predetermined time period elapses, the proportionally calculated discount rate may be initialized.

For example, when the cumulative number of uses by a certain group reaches 30 in a predetermined time period of one month from a first purchase of a product, a discount rate proportional to 30 purchases is applied to a member who makes the thirtieth purchase.

However, the proportionally increasing discount rate is initialized thereafter, that is, after the previously set time period of one month elapses, and the initialized discount rate is applied to a member who makes a purchase after the one month.

In other words, a discount rate for a first purchase may be applied again. This may be continuously repeated at predetermined time periods, and may have an effect of increasing a desire for purchasing.

The discount rate management module 340 in the service apparatus 300 according to the second embodiment of the present invention may set one or more target values of the number of times in which a certain group uses an affiliated store available for the group, and target-value-specific discount rates corresponding to the target values.

Here, the target values and the discount rates corresponding to the target values may be set by any one of the affiliated store terminal 200 and the service apparatus 300.

Specifically, when a certain member purchases a product in the affiliated store, it is possible to transmit a payment request to the service apparatus 300 through the affiliated store terminal 200 and check information on the member through member information transmitted together with the payment request.

Also, through the affiliated store usage management module 320 of the service apparatus 300, it is possible to manage the cumulative number of times using an affiliated store by each member of the group or the cumulative number of uses of the whole group, according to affiliated stores. Therefore, the discount rate management module 340 in the service apparatus 300 according to the second embodiment of the present invention may set and provide a target value of the number of uses of an affiliated store and a discount rate corresponding to the target value to a member, thereby providing different discount rates to respective members according to the respective members' cumulative numbers of uses. Also, when the sum of cumulative numbers of uses of all members in a certain group reaches a target value, the same discount rate may be provided to all the members of the group.

The above methods may be easily selectable by a person implementing the present invention.

As described above, when the cumulative number of uses of an affiliated store by each member or a certain group reaches a target value, it is possible to calculate a preset discount rate.

When the service apparatus 300 receives a payment request from the affiliated store terminal 200, the discount rate management module 340 according to the third embodiment of the present invention may check the service usage information DB 312 in the storage module 310 of the service apparatus 300 and modify the calculated discount rate according to at least one of the history of cumulative uses of an affiliated store and the cumulative payment amount.

For example, when respective members of a certain group have different numbers of times using an affiliated store, it is possible to check member-specific histories of cumulative uses of the affiliated store and member-specific cumulative payment amounts, and apply an additional discount to a member who has used the affiliated store most frequently or has the largest cumulative payment amount at the affiliated store by applying a ranking value of the cumulative number of uses and a cumulative payment amount to the calculated discount rate.

A discount service method according to the sequence of using an affiliated store according to embodiments of the present invention will now be described.

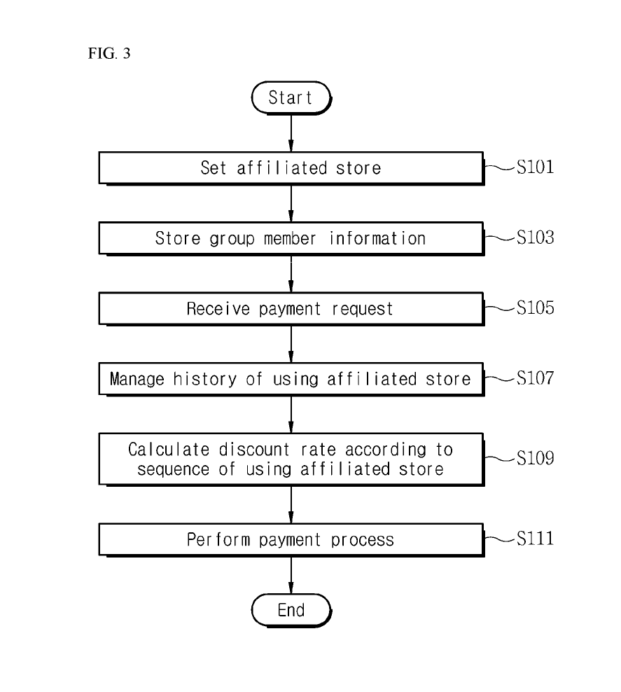

FIG. 3 is a flowchart illustrating a service method of a discount service apparatus based on the sequence of using an affiliated store according to embodiments of the present invention.

Referring to FIG. 3, the overall flow of the present invention's discount service according to a usage sequence can be seen.

First, in operation S101, the service apparatus 300 sets an affiliated store that provides the present invention's service of providing a discount according to a usage sequence at a request of a terminal device 100 so that a certain group may be provided with the service. In operation S101, a request of the certain terminal device 100 sets an affiliated store that will be used to receive the service of the present invention by a group which the terminal device 100 belongs to. It is also possible to receive a request from the affiliated store terminal 200 and set an affiliated store list by selecting affiliated stores with reference to affiliated store information stored in the affiliated store information DB 313 in the storage module 310 of the service apparatus 300.

Subsequently, in operation S103, the service apparatus 300 stores information on members of the group which the terminal device 100 belongs to in the member information DB 311 of the storage module 310 at a request of the terminal device 100.

Here, the member information DB 311 represents group member information.

The group member information may include at least one of the names of groups to which members belong, the list of affiliated stores which has been set in operation S101 and will be used by the group, member names, and terminal identification information.

Also, the group member information may further include at least one piece of information among information for identifying users, such as member IDs and personal identification codes of the members.

Subsequently, when a member of the group inputs a signal for a payment request to the affiliated store terminal 200 of the affiliated store set to be used by the group in operation S101 using the terminal device 100 to receive the present invention's discount service according to the sequence of using an affiliated store, the affiliated store terminal 200 transmits the payment request to the service apparatus 300, and the service apparatus 300 receives the payment request (S105).

When the payment request is received, the service apparatus 300 maps member information, which is received together with the payment request and regards the group member who has requested payment, to group member information stored as the member information DB 311 in the storage module 310 of the service apparatus 300, authenticates who is a group member corresponding to the payment request, and manages a history of using the affiliated store to update the service usage information DB 312 stored in the storage module 310 of the service apparatus 300 (S107).

Subsequently, the service apparatus 300 may calculate a discount rate according to the sequence of using the affiliated store with reference to the service usage information DB 312 of the storage module 310 including the history of using the affiliated store managed by the affiliated store usage management module 320 in operation S107 (S109). Subsequently, the calculated discount rate is applied, and a payment for a product purchase in the affiliated store that receives the payment request is approved, so that a payment process is performed (S111).

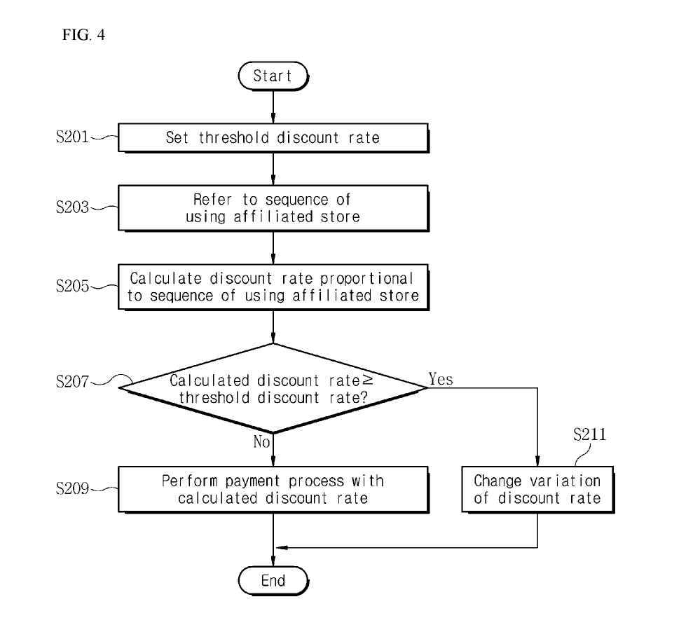

FIG. 4 is a flowchart illustrating a method of calculating a discount rate proportional to the sequence of using an affiliated store according to the first embodiment of the present invention.

Referring to FIG. 4, in operation S201, the service apparatus 300 may set one or more threshold discount rates for the present invention's discount rate calculation according to the sequence of using an affiliated store.

At this time, the threshold discount rate may be set in the affiliated store terminal 200 and the service apparatus 300, and are set for a discount rate increasing in proportion to the sequence of using the affiliated store.

In the service apparatus 300 according to the first embodiment of the present invention, a discount rate is proportional to a usage sequence, and thus a calculated discount rate increases with an increase in the number of uses.

When a payment request is received from the affiliated store terminal 200 after the threshold discount rate is set, the service apparatus 300 may refer to the sequence of using the affiliated store in the history of using the affiliated store in the service usage information DB 312 of the storage module 310 (S203).

Then, the service apparatus 300 calculates a discount rate in proportion to the usage sequence which has been checked by the discount rate management module 340 in operation S203 to calculate a discount rate (S205).

Here, the calculated discount rate and the preset threshold discount rate are compared with each other (S207). When the calculated discount rate is smaller than the threshold discount rate, the service apparatus 300 may perform a payment process with the discount rate calculated in operation S205 (S209).

On the other hand, when the calculated discount rate is the threshold discount rate or more, the service apparatus 300 perform a payment process with the discount rate calculated in operation S205 and changes a variation of the discount rate for subsequent payment requests (S211).

Through operation S211, a slightly smaller increase in discount rate may be shown in later payment requests. For example, when a threshold discount rate preset in operation S201 is 20%, the discount rate calculated according to a sequence of a member using the affiliated store at the request of the affiliated store terminal 200 is 25%, and an increase in discount rate according to a usage sequence is 2%, the increase in discount rate is changed from 2% to 1% because the calculated discount rate of 25% is the preset threshold discount rate of 20% or more. In other words, an increase in discount rate may be reduced to 1% beginning with a next purchase.

According to the above description, a discount rate of 21% may be applied to the next purchase. In other words, when a calculated discount rate exceeds a set threshold discount rate, an increase in discount rate may be reduced, and an excessive load of discount exerted on the affiliated store may be reduced.

The service apparatus 300 according to the second embodiment of the present invention may set a threshold discount rate as described above with reference to FIG. 4 to avoid gradually increasing the excessive load of discount on an affiliated store. In addition, the service apparatus 300 may set a predetermined time period to a period at which a discount rate is initialized, and initialize the discount rate increasing in proportion to a usage sequence to the same value as a discount rate for the first usage sequence when the predetermined time period elapses.

For example, when the predetermined time period for discount rate initialization of the service apparatus 300 is set to 100 days, the discount rate increasing in proportion to a usage sequence may be initialized 100 days after the first use of the affiliated store. Therefore, members of each group may be provided with the discount service according to a new usage sequence every 100 days.

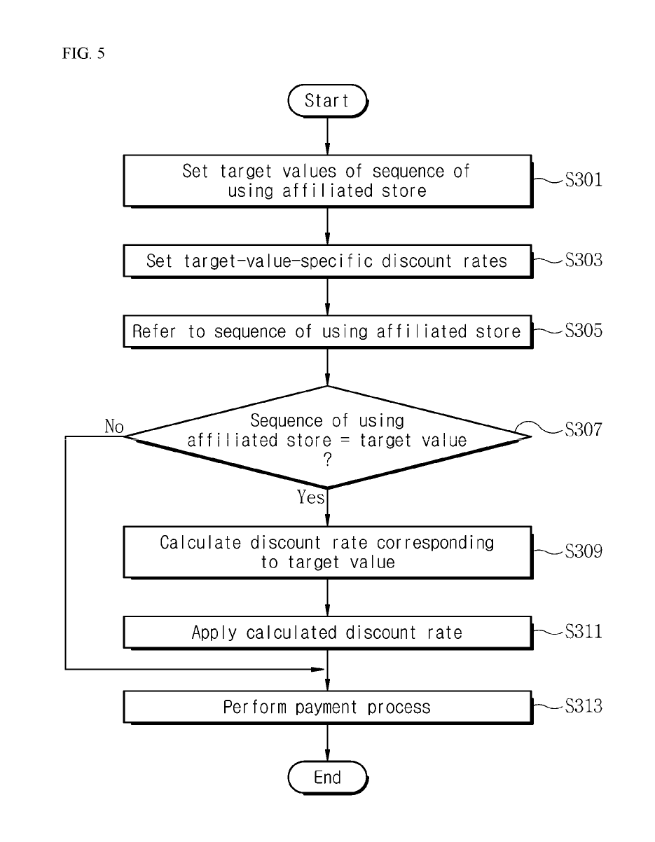

FIG. 5 is a flowchart illustrating a method of providing a discount rate dependent on a target value of a usage sequence according to the second embodiment of the present invention.

Referring to FIG. 5, it can be seen that, in the second embodiment of the present invention, a target value of the sequence of using an affiliated store registered to be available for a certain group and a discount rate corresponding to the target value are set, a usage sequence is managed, and the target-value-specific discount rate set together with the target value is calculated, unlike the first embodiment in which the discount rate is calculated in proportion to a usage sequence.

Specifically, in operation S301, a target value of the sequence of using an affiliated store is set. At this time, one or more target values may be set to provide different discount rates according to stages of the number of uses.

Therefore, it is possible to manage usage histories of respective members of a certain group and provide different discount rates to the respective members, and it is also possible to sum the cumulative numbers of uses of all group members and provide the same discount rate to the all members. Also, the service apparatus 300 sets a discount rate corresponding to the target value of the sequence of using the affiliated store set in operation S301 (S303). Subsequently, the service apparatus 300 may refer to the sequence of using the affiliated store through the service usage information DB 312 in the storage module 310 of the service apparatus 300 to calculate a discount rate for a payment request of the affiliated store terminal 200 (S305).

Here, it is determined whether the sequence of using the affiliated store checked in operation S305 has reached the preset target value (S307).

When the sequence of using the affiliated store reaches the previously set target value, the preset discount rate corresponding to the target value set in operation S303 is calculated (S309) and applied (S311), and a payment process is performed (S313).

On the other hand, when the checked sequence of using the affiliated store has not reached the previously set target value, the payment process may be performed without the new discount rate applied (S313).

For example, when a target value of a first stage among one or more target values has been achieved in the case of a previous payment request but a target value of a second stage is not achieved in the case of a new payment request, a target-value-specific discount rate set for the first target value may be maintained, and the payment process may be performed (S313).

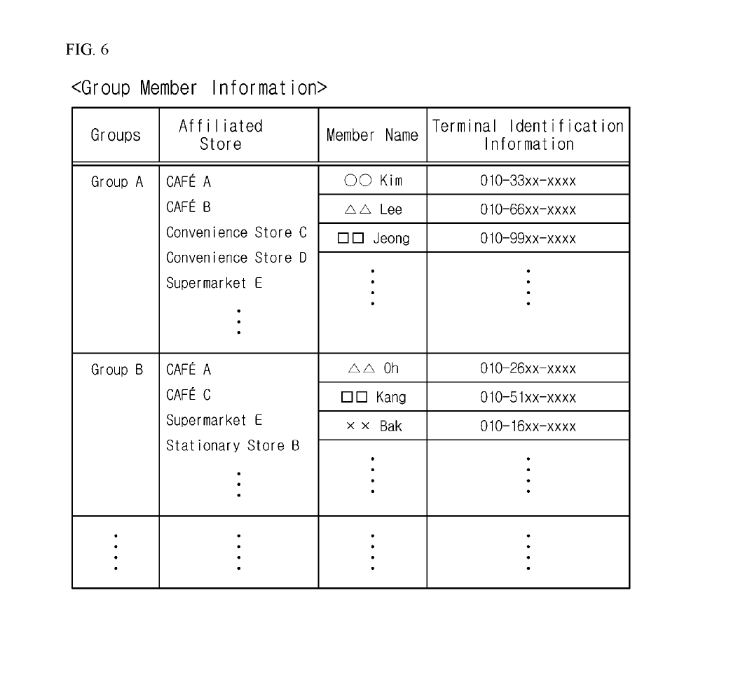

FIG. 6 shows an example of a structure of a member information DB according to embodiments of the present invention.

Referring to FIG. 6 showing an example of managed group member information, a member information DB is stored by the storage module 310 of the service apparatus 300 according to embodiments of the present invention.

The group member information includes group names, lists of affiliated stores used by the groups, the names of members of the groups, and terminal identification information according to the groups.

Also, the group member information may further include at least one piece of information among information for identifying users, such as member IDs and personal identification codes of the members. Referring to FIG. 6, the list of affiliated stores available for group A, the names of members, and terminal identification information corresponding to the names of members are listed, and the group member information is stored and managed in the service apparatus 300 at a request of the terminal device 100 according to exemplary embodiments of the present invention.

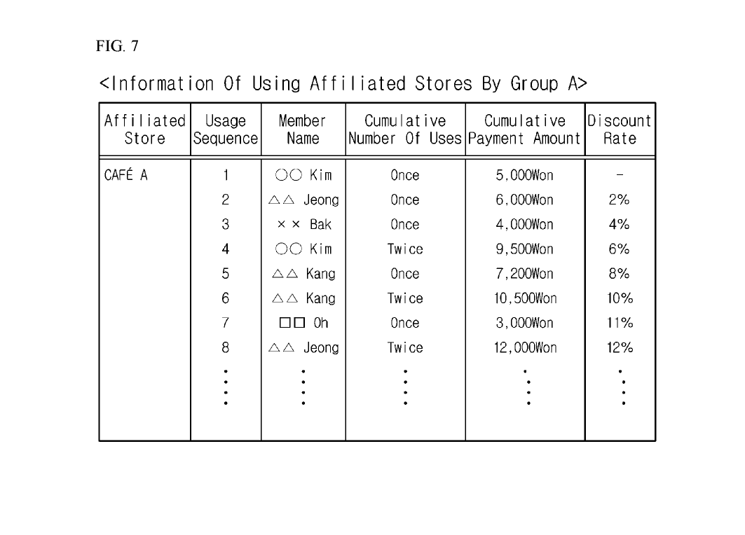

FIG. 7 shows an example of a service usage information DB managed by an affiliated store usage management module according to embodiments of the present invention.

FIG. 7 shows a history of using café A which is in the list of affiliated stores of group A shown in FIG. 6.

According to embodiments of the present invention, affiliated store usage information may be checked through the service usage information DB 312 of the service apparatus 300, and managed by the affiliated store usage management module 320 of the service apparatus 300.

Referring to FIG. 7, numbers indicating the sequence of group A using café A are listed, and the names of members, cumulative numbers of uses, cumulative payment amounts, and discount rates calculated according to a sequence of the members using the affiliated store are shown according to the sequence of using café A.

When a payment request is received, the group member authentication module 330 of the service apparatus 300 may map member information received together with the payment request to the member information DB 311 to authenticate a member, and the affiliated store usage management module 320 may manage the group-specific affiliated store usage information of FIG. 7 through the service usage information DB 312. In the following description, it is assumed that a variation of a discount rate and a threshold discount rate are set by the affiliated store terminal 200 or the service apparatus 300, and in FIG. 7, the variation and the threshold discount rate are set to 2% and 10%, respectively.

Referring to FIG. 7, it can be seen that, for affiliated store usage having a usage sequence increasing from 1, discount rates for first to third purchases are 0%, 2%, and 4% respectively, that is, a discount rate increases by 2%.

If the threshold discount rate has been set to 10% when the discount rate reaches 10%, it is possible to see that the discount rate's variation of 2% is reduced to 1% for purchases after the discount rate of 10%.

In other words, the discount rate changes to 11% for a seventh purchase and to 12% for an eighth purchase.

Here, one or more threshold discount rates may be set.

Meanwhile, the service apparatus 300 may also manage the cumulative numbers of uses and the cumulative payment amounts.

Also, with reference to the cumulative numbers of uses and the cumulative payment amounts, the service apparatus 300 may differentially provide an additional discount rate to a member having the largest cumulative number of uses and the largest cumulative payment amount in addition to a calculated discount rate.

In other words, in FIG. 7, since ∘∘ Kim of a fourth usage sequence and ΔΔ Jeong of an eighth usage sequence both have a cumulative usage number of two, the calculated discount rates are 6% and 12% respectively, and additional discounts may be further provided.

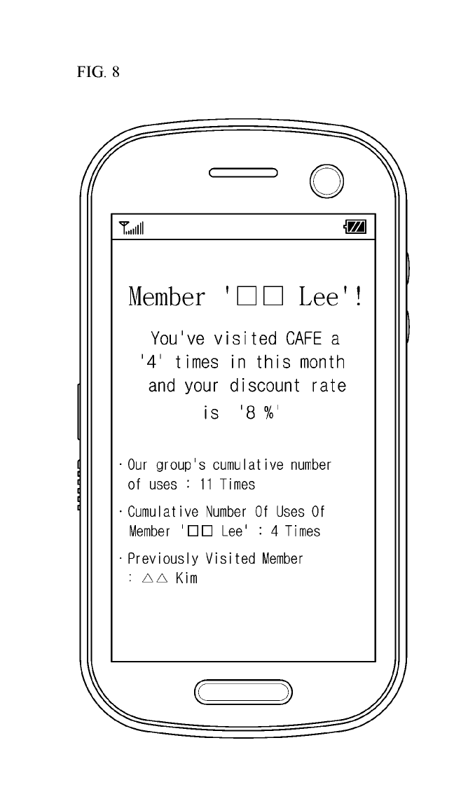

FIG. 8 is an example of a screen illustrating a method of providing a discount based on the sequence of using an affiliated store according to the first embodiment of the present invention in which a discount rate is calculated in proportion to the sequence of using an affiliated store.

Referring to FIG. 8, it is possible to see that the member “□□ Lee” has visited café A four times, and a discount rate is “8%.”

Here, the number of visits during this month is shown because the discount rate is initialized every predetermined time period according to the first embodiment.

In other words, in FIG. 8, it can be seen that the discount rate is set to be initialized on the first day of each month, the cumulative number of uses of a group which the member “□□ Lee” belongs to is 12, and “□□ Lee” has visited café A four times in this month.

Also, it can be seen that “ΔΔ Kim” of the same group has used café A before the this visit of “□□ Lee.”

A discount rate for the purchase has been calculated to be 8% according to a 12^{th} usage sequence. Here, the discount rate may be set differently according to a standard of each affiliated store.

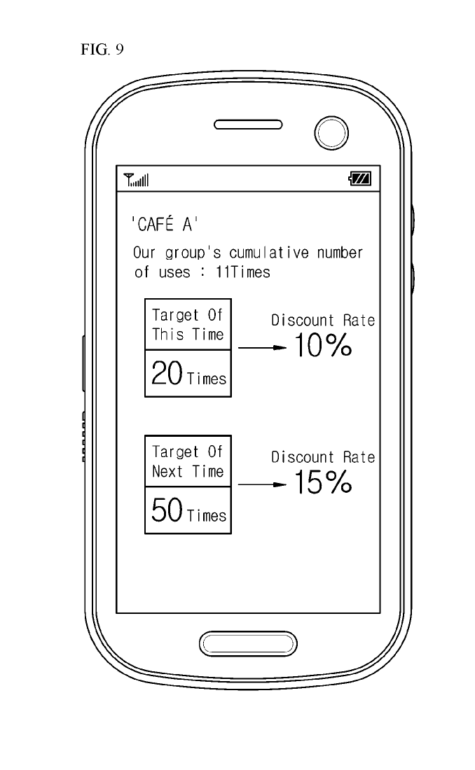

FIG. 9 is an example of a screen illustrating a method of providing a discount based on the sequence of using an affiliated store according to the second embodiment of the present invention in which target values of a usage sequence and target-value-specific discount rates are set and then a discount rate is calculated.

FIG. 9 shows a screen that may be seen in terminal devices 100 of group members, indicating that the group's cumulative number of uses of café A is 11.

Also, it is shown that a target value of the number of uses of the affiliated store is 20, the corresponding discount rate is 10%, a next target value is 50, and the corresponding discount rate is 15%. The target values and the corresponding discount rates are set by the affiliated store terminal 200 and may be different according to affiliated stores.

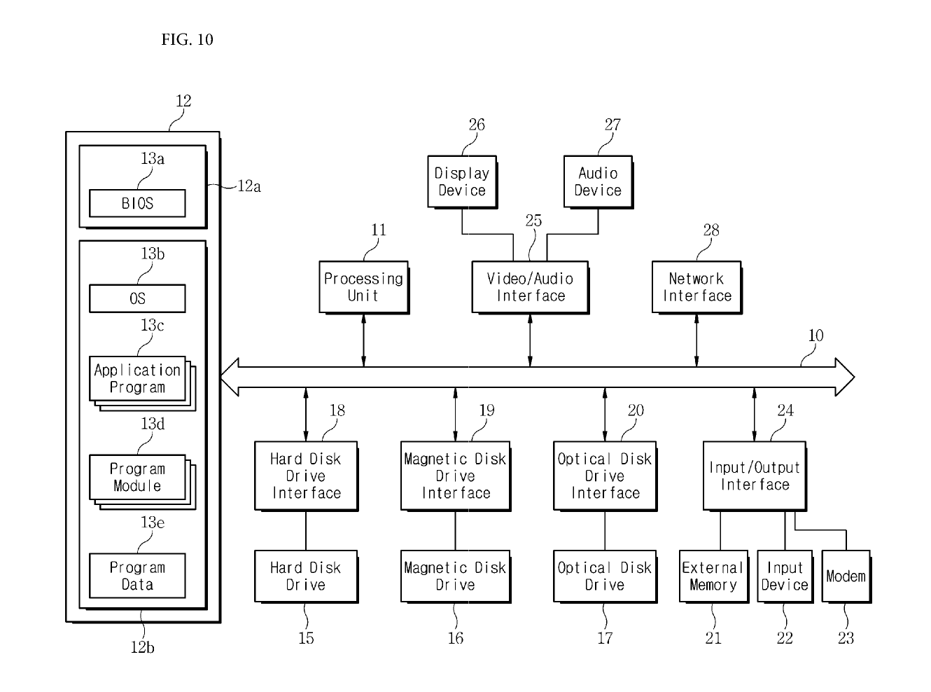

FIG. 10 is a diagram showing an operating environment of a discount service apparatus based on the sequence of using an affiliated store according to embodiments of the present invention.

With reference to FIG. 10, a simple and general description of an appropriate computing environment in which embodiments of the present invention may be implemented will be provided below. Although not required, embodiments of the present invention may be described in relation to computer-executable instructions, such as program modules executed by a computer system.

In general, program modules include routines, programs, objects, components, data structures, etc. that perform particular tasks or implement particular abstract data types. Computer-executable instructions, associated data structures, and program modules represent examples of program code means for performing operations of the present invention disclosed herein.

Referring to FIG. 10, an exemplary computing system for implementing embodiments of the present invention includes a computing apparatus including a processing unit 11, a system memory 12, and a system bus 10 which connects a variety of system components including the system memory 12 to the processing unit 11.

The processing unit 11 may execute computer-executable instructions designed to implement features of the present invention.

The system bus 10 may be any of several types of bus structures including a local bus, a peripheral bus, and a memory bus or a memory controller using any of various bus architectures. The system memory 12 includes a ROM 12a and a RAM 12b. In general, a basic input/output system (BIOS) 13a containing basic routines that help information transfer between components within the computing system, such as during start-up, may be stored in the ROM 12a.

The computing system may include storage means, for example, a hard disk drive 15 for reading information from a hard disk or writing information to the hard disk, a magnetic disk drive 16 for reading information from a magnetic disk or writing information to the magnetic disk, and an optical disk drive 17 for reading information from an optical disk, for example, a CD-ROM or other optical media, or writing information to the optical disk. The hard disk drive 15, the magnetic disk drive 16, and the optical disk drive 17 are connected to the system bus 10 by a hard disk drive interface 18, a magnetic disk drive interface 19, and an optical disk drive interface 20, respectively.

In addition, the computing system may further include an external memory 21 as a storage means. The external memory 21 may be connected to the system bus 10 through an input/output (I/O) interface 24.

The aforementioned drives and their associated computer-readable media that are subjected to reading and writing by the drives provide non-volatile storage of computer-executable instructions, data structure, program modules, and other data. Although the exemplary environment described herein employs the hard disk drive 15, the magnetic disk drive 16, and the optical disk drive 17, other types of computer-readable media, which include magnetic cassettes, flash memory cards, DVDs, Bernoulli cartridges, RAMs, ROMs, etc., for storing data may be used.

Program code means including one or more program modules, which include an operating system (OS) 13b, one or more application programs 13c, other program modules 13d, and program data 13e loaded and executed by the processing unit 11, may be stored in the hard disk drive 15, the magnetic disk drive 16, the optical disk drive 17, the ROM 12a, or the RAM 12b.

Through other input devices 22 such as a keyboard, a pointing device, a microphone, a joystick, a game pad, a scanner, etc., a user may input commands and information to the computing system.

These input devices 22 may be connected to the processing unit 11 through the I/O interface 24 connected to the system bus 10.

The I/O interface 24 may logically represents any of a wide variety of different interfaces, for example, a serial port interface, a personal system 2 (PS/2) interface, a parallel port interface, a universal serial bus (USB) interface, or an Institute of Electrical and Electronics Engineers (IEEE) 1394 interface (i.e., a FireWire interface), or may even logically represent a combination of different interfaces.

In addition, the computing system to which embodiments of the present invention are applied may further include a display device 26, such as a monitor or a liquid crystal display (LCD), and an audio device 27, such as speakers or a microphone. These are connected to the system bus 10 through a video/audio interface 25.

Other peripheral output devices (not shown), for example, a printer, may also be connected to the computing system. The video/audio interface 25 may include a high definition multimedia interface (HDMI), a graphics device interface (GDI), and so on.

The computing system for implementing embodiments of the present invention may be connected to networks, for example, an office-wide or enterprise-wide computer network, a home network, an intranet, and/or the Internet. The computing system may exchange data with external sources, for example, remote computer systems, remote applications, and/or remote DBs, through such networks.

To this end, the computing system to which embodiments of the present invention are applied includes a network interface 28 that receives data from external sources and/or transmits data to external sources.

In embodiments of the present invention, the computing system of the service apparatus 300 may exchange data with a terminal device 100 and the affiliated store terminal 200 at remote places through the network interface 28.

The network interface 28 may be represented as a logical combination of one or more software and/or hardware modules, for example, a network interface card and the corresponding network driver interface specification (NDIS) stack.

Likewise, through the I/O interface 24, the computing system receives data from external sources or transmits data to external sources. The I/O interface 24 may be connected to a modem 23 (e.g., a standard modem, a cable modem, or a digital subscriber line (DSL) modem), through which the computing system may receive data from external sources and/or transmit data to external sources.

FIG. 10 represents a suitable operating environment for the present invention, but the principles of the present invention may be employed in any system that is capable of implementing the principles of the present invention with suitable modification if necessary. The environment shown in FIG. 10 is illustrative only and by no means represents even a small portion of the wide variety of environments in which the principles of the present invention may be implemented.

Various information generated by executing a program of the present invention for providing the discount service according to the sequence of using an affiliated store may be stored in any computer-readable medium related to a computing system as shown in FIG. 10 and accessed.

For example, some of these program modules and some of associated program data may be included in the OS 13b, the application programs 13c, the program modules 13d, and/or the program data 13e for storage in the system memory 12.

When a mass storage device such as a hard disk is connected to the computing system, such program modules and associated program data may be stored in the mass storage device.

In a network environment, program modules related to the present invention or some part thereof may be stored in remote memory storage devices, for example, system memories and/or mass storage devices associated with computing systems of the terminal devices 100 and the affiliated store terminal 200, connected through the modem 23 of the I/O interface 24 or the network interface 28. These modules may be executed in a distributed environment as described above.

While this specification contains many specific implementation details as described above, these should not be construed as limitations on the scope of any inventions or of what may be claimed, but rather as descriptions of features specific to particular implementations of particular inventions. Certain features of the invention, which are described in the context of separate embodiments, may also be implemented in combination in a single embodiment.

Conversely, various features that are described in the context of a single embodiment may also be implemented separately or in any suitable sub-combination in a plurality of embodiments. Although features may be described above as acting in certain combinations and even initially claimed as such, one or more features from a claimed combination may be omitted from the combination in some cases, and the claimed combination may be directed to a sub-combination or variation of a sub-combination.

Similarly, while operations are illustrated in the drawings in a particular order, this should not be understood as requiring that such operations be performed in the particular order illustrated or in sequential order, or that all illustrated operations be performed, to achieve desirable results. In particular cases, multitasking and parallel processing may be advantageous. Also, the separation of various system components in the embodiments described above should not be understood as requiring such separation in all embodiments, and it should be understood that the described program components and systems may generally be integrated together in a single software product or packaged into multiple software products.

Particular embodiments of the subject matter have been described herein. Other embodiments are within the scope of the following claims. For example, the actions recited in the claims may be performed in a different order and still achieve desirable results. In addition, the processes illustrated in the accompanying drawings do not necessarily require the particular order illustrated or sequential order to achieve desirable results. In particular embodiments, multitasking and parallel processing may be advantageous.

The written description sets forth the best mode of the invention and provides examples to describe the invention and to enable those or ordinary skill in the art to make and use the invention. This written description does not limit the invention to the precise terms set forth. Therefore, while the invention has been described in detail with reference to the examples set forth above, those of ordinary skill in the art may effect alterations, modifications, and variations to the examples without departing from the scope of the invention.

Accordingly, the scope of the invention should be determined by the claims rather than the described embodiments.

The detailed description of the preferred embodiments of the present disclosure has been given to enable those skilled in the art to implement and practice the disclosure. Although the disclosure has been described with reference to the various embodiments, those skilled in the art will appreciate that various modifications and variations can be made in the present disclosure without departing from the subject matter, the spirit and scope of the disclosure. Specific terms used in this disclosure and drawings are used for illustrative purposes and not to be considered as limitations of the present disclosure.

The present invention relates to a discount service method according to the sequence of using an affiliated store and an apparatus for the same. In the present invention, when an affiliated store is used by members of a group formed for similar preferences or as a club or a social gathering, the sequence of using the affiliated store is managed to increase a discount rate according to the usage sequence, so that favorite stores can be shared among the group members.

In the present invention, a discount rate increases according to the sequence of using an affiliated store, but is initialized after a predetermined time period. Therefore, it is possible to arouse a desire for purchasing.

In the present invention, when a target value of a usage number is set and achieved, a preset discount rate can be provided. Therefore, it is possible to arouse members' desires for achievement and desires for purchasing.

In the present invention, a discount rate increases according to the sequence of using an affiliated store, but a variation of the discount rate is changed when the discount rate reaches a threshold discount rate. Therefore, it is possible to provide a discount rate of a practically possible level.

The present invention may be useful for affiliated stores to attract regular customers and manage customers.

There is enough possibility to commercialize or sell the present invention, and the present invention can be clearly implemented in practice. Consequently, the present invention has industrial applicability.

In this specification, exemplary embodiments of the present invention have been classified into the first, second and third exemplary embodiments and described for conciseness. However, respective steps or functions of an exemplary embodiment may be combined with those of another exemplary embodiment to implement still another exemplary embodiment of the present invention.

What is claimed is:

1. A service apparatus for a discount according to a sequence of using an affiliated store, the service apparatus comprising:
a storage module configured to store group member information including at least one of lists of affiliated stores available for respective groups, identification information of group members, and terminal identification information;
a group member authentication module configured to receive a payment request from an affiliated store and authenticate whether the payment request is a payment request of a group member by comparing the payment request with the group member information;
an affiliated store usage management module configured to manage affiliated store usage information including at least one of a sequence of using the affiliated store, a name of the group member, a history of cumulative uses of the affiliated store, and a cumulative payment amount based on the payment request of the group member; and
a discount rate management module configured to calculate a discount rate according to the sequence of using the affiliated store when the payment request is authenticated to be a payment request of a group member.

2. The service apparatus of claim 1, wherein the discount rate management module calculates the discount rate in proportion to the sequence of using the affiliated store.

3. The service apparatus of claim 2, wherein the discount rate management module sets one or more threshold discount rates, and changes a variation of the discount rate when the calculated discount rate reaches the set threshold discount rates.

4. The service apparatus of claim 2, wherein, when a predetermined time period elapses, the discount rate management module initializes the discount rate to manage the sequence of using the affiliated store, and calculates a discount rate in proportion to the sequence of using the affiliated store.

5. The service apparatus of claim 1, wherein the discount rate management module sets one or more target values of the sequence of using the affiliated store and target-value-specific discount rates, and calculates the discount rate by comparing the sequence of using the affiliated store and the one or more target values.

6. The service apparatus of claim 1, wherein the discount rate management module modifies the calculated discount rate according to at least one of the history of cumulative uses of the affiliated store and the cumulative payment amount.

7. A method for a service apparatus to provide a discount according to a sequence of using an affiliated store, the method comprising:
setting group member information including at least one of lists of affiliated stores available for respective groups, identification information of group members, and terminal identification information;
receiving a payment request from an affiliated store, and authenticating whether the payment request is a payment request of a group member by comparing the payment request with the group member information;
managing affiliated store usage information including at least one of a sequence of using the affiliated store, a name of the group member, a history of cumulative uses of the affiliated store, and a cumulative payment amount based on the payment request of the group member;
calculating a discount rate according to the sequence of using the affiliated store when the payment request is a payment request of a group member; and
applying the calculated discount rate to perform a payment process.

8. The method of claim 7, wherein the calculating of the discount rate includes calculating the discount rate in proportion to the sequence of using the affiliated store.

9. The method of claim 8, wherein the calculating of the discount rate further includes:
setting one or more threshold discount rates; and
changing a variation of the discount rate when the calculated discount rate reaches the threshold discount rates.

10. The method of claim 7, wherein the calculating of the discount rate further includes:
changing the calculated discount rate according to at least one of the history of cumulative uses of the affiliated store and the cumulative payment amount.

11. The method of claim 7, wherein the calculating of the discount rate includes:
designating one or more target values of the sequence of using the affiliated store and discount rates corresponding to the target values;
determining whether the sequence of using the affiliated store reaches the target values; and
calculating and applying the designated discount rates to an amount to be paid when the sequence of using the affiliated store reaches the target values.
